(19) United States
(12) Patent Application Publication
(10) Pub. No.: US 2015/0035368 A1
(43) Pub. Date: Feb. 5, 2015

(54) Smart Power Consumer

(71) Applicant: Daniel M. Perecky, Fishkill, NY (US)

(72) Inventor: Daniel M. Perecky, Fishkill, NY (US)

(21) Appl. No.: 13/954,005

(22) Filed: Jul. 30, 2013

(51) Int. Cl. H02J 4/00

(52) U.S. Cl. CPC H02J 4/00
USPC 307/66

(57) ABSTRACT

This invention describes the Smart Power Consumer product, which is a product that can be attached or integrated during the manufacture of all computers, tablets or generic electrical devices that employ a rechargeable battery. The purpose of the Smart Power Consumer is the use the built-in battery as much as practically possible, thereby reducing the electrical load and correspondingly reducing the electrical bill of the owner who pays for said electricity. The user of the computer, tablet or generic electrical device then has the best of both worlds: They operate using their rechargeable battery as much as possible, while consuming no other electricity. Then-when it is needed, and only when it is needed: the Smart Power Consumer automatically connects the computer, tablet or generic electrical device back to a wall power source to replenish. This will result in a greener earth, help with ecology and enable users to be more self-sustaining, smarter consumers of electricity.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

The invention pertains to any computer, tablet or other electronic device that utilizes a rechargeable battery and alternately, a normal, conventional household or industrial electrical power source from a wall outlet or similar.

### BRIEF SUMMARY OF THE INVENTION

To use the computer, tablet or electronic devices' built-in battery as much as practically possible—thereby saving/conserving power consumption from the grid. This will translate to a corresponding reduction of electrical usage by the customer.

### BRIEF DESCRIPTION OF THE SEVERAL VIEWS OF THE DRAWING

Note: The GUI controls shown in FIGS. 1, 2 and 3 can be aggregated and/or combined to best suit what the manufacturer would consider to be most appropriate for the product and/or the customer.

FIG. 1

GUI control type radio buttons depict the main operational modes to use the Smart Power Consumer product in.
50—run in automatic mode
51—run in manual mode

FIG. 2

GUI control type input box that is used to specify the minimal charge level the battery is allowed to deplete to. There are optionally two (or one integrated) of these if the Smart Power Consumer has both automatic and manual mode features available for the user. One input box, or more specifically, a minimal charge level can be set for each run mode. This setting will not be ‘0’. A default minimal setting will be specified, and the Smart Power Consumer program will not allow it to be set to a smaller figure than the default amount.
52—input/specify a percentage of charge battery is allowed to deplete to.

FIG. 3

Manual Mode GUI control type input boxes.
53—User specifies time between programmatic checks of battery level.
54—User specifies time allowed, or percentage level to charge up to. This is a fixed time value or a percent value that the user will specify.

FIG. 4

Shows a computer, tablet or generic electrical device that uses the Smart Power Consumer as a separate purchased product. In this case, the Smart Power Consumer is then attached to the computer, tablet or generic electrical device by means of the connector 61, the normally-closed relay depicted in 59 where the electrical plug for the electrical device is plugged in to. The relay in 59 has the feature to be plugged into the regular wall outlet in lieu of the computer, tablet or other generic electrical devices' electrical plug.
55—The computer, tablet, or generic electrical device.
56—The power cord of the computer, tablet, or generic electrical device.
57—The power adapter box for the computer, tablet, or generic electrical device.
58—The power plug for the computer, tablet, or generic electrical device.
59—The enclosed-device, normally closed relay for the Smart Power Consumer.

This device is plugged into the wall outlet, and has a female plug which allows the power plug —58, to be plugged into it.
60—A signal cable used to control the operation of the normally closed relay—59.
61—A connector for the signal cable—60, to connect to the computer, tablet, or generic electrical device. This can be a USB type connector, a serial type connector, or other type.

FIG. 5

Shows a computer, tablet or generic electrical device that uses the Smart Power Consumer with the normally closed relay as an integrated product. It is built into the power adapter box—63, power cord—64, and 65—for the computer, tablet, or generic electrical device.
62—The computer, tablet, or generic electrical device manufactured with the Smart Power Consumer software and hardware built into its relevant parts.
63—The power adapter box for the computer, tablet, or generic electrical device, which includes FIG. 4, 59: the normally closed relay built into it.
64—The signal cable for the built-in Smart Power Consumer, integrated with the power cable of the computer, tablet, or generic electrical device and using the same connector as 56 in FIG. 4, but with the appropriate addition of this cable connector to accommodate the Smart Power Consumer signal wire.
65—Depicts a cable that is thicker than in FIG. 5, 66: as it contains both the normal power plus 64—the Smart Power Consumer signal cable
66—Shows a normal, conventional two-wire power cable connected to 63—the computer, tablet, or generic electrical device power adapter box. The computer, tablet, or generic electrical device power adapter box again includes 59 in FIG. 4, the normally closed relay.

### DETAILED DESCRIPTION OF THE INVENTION

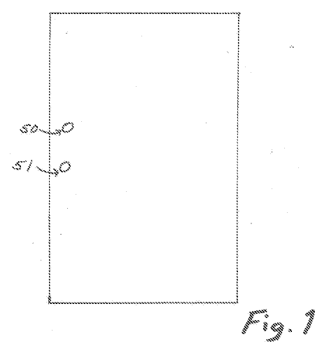

The Smart Power Consumer is designed to use as much as practically possible the power from the rechargeable battery of a computer, tablet or generic electrical device. For general descriptive purposes, there are two basic operating modes to choose: Automatic—FIG. 1, 50 and Manual—FIG. 1, 51. More aspects of the options to these two modes are described later in the CLAIMS section.

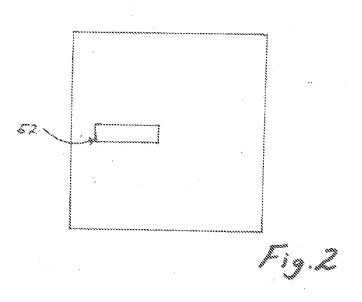

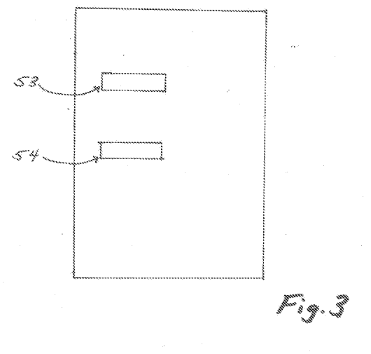

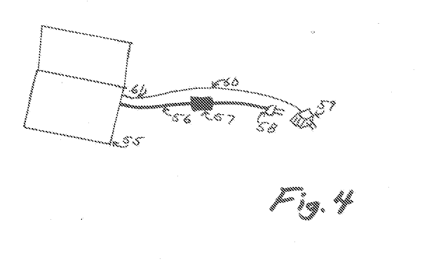

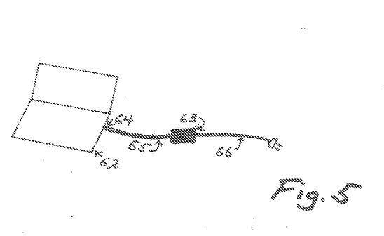

In automatic mode, the process of operation follows: If the battery power is depleted less than the minimal battery level amount as set by the user, which is specified by the minimal amount in FIG. 2, 52, essentially nothing happens. The Smart Power Consumer leaves the normally closed relay closed—to allow the battery to recharge to full. Once the battery is full, the normally closed relay for the Smart Power Consumer—FIG. 4, 59 will be opened. This will disconnect/liberate the computer, tablet, or generic electrical device electrically from the power in the wall power source, and allow it to operate solely under its battery power. The software component of the Smart Power Consumer will monitor both the electrical battery charge and how long the battery holds the electrical charge, until it reaches the minimal battery level amount as set by the user—which is specified by the minimal amount in FIG. 2, 52.

When the battery is fully charged and the normally closed relay is then opened, based on the battery drainage rate, a program algorithm of Smart Power Consumer in the computer, tablet, or generic electrical device will frequently check the then current battery charge. A reasonable fixed time will pass until the Smart Power Consumer determines of how long a time in between checks are necessary to ensure that the battery does not get depleted below the minimal battery level amount FIG. 2, 52, set by the user.

This regular periodic check, or quiesce mode, is then the normal operational phase that the Smart Power Consumer achieves. The fixed time determined as described in the previous paragraph is used to regularly check the battery level.

Once the battery is detected to be just greater than the minimal battery level amount set in FIG. 2, 52, the Smart Power Consumer program will close the normally closed relay FIG. 4, 59, to allow the battery to charge 100% full.

Once fully charged, the normally closed relay in FIG. 4, 59 will then open and the cyclic process of monitoring battery drainage repeats itself, starting at paragraph [0014] again.

In manual mode, this process utilizes much of same algorithm as described in automatic mode, but with two user-controllable settings specified by: FIG. 3, 53 and FIG. 3, 54.

FIG. 3, 53 specifies manually how long the Smart Power Consumer should wait in between (elapsed time) to repeatedly check battery drainage/usage level, so that it does not go below the level specified by the minimal amount in FIG. 2, 52. This setting will not be ‘0’. A default minimal setting will be specified, and the Smart Power Consumer program will not allow it to be set to a smaller figure than the default amount.

FIG. 3, 54 specifies either how much of a charge should be given. FIG. 3, 54 can be specified either in percent charged, or in absolute minutes of charge time.

In both automatic and manual modes, when charging the battery, the checking of the battery level continues. This checking is to see if the battery is full (in automatic mode), or in

1a. The Smart Power Consumer product reduces the overall electrical bill the owner of this product would otherwise create by utilizing the computer, tablet, or generic electrical devices' built-in battery as much as practically possible.

2a. The Smart Power Consumer product can be sold as a separate product as depicted in FIG. 4, which can then be connected to a computer, tablet, or generic electrical device as shown.

2b. Alternatively to the configuration described in 2a above, the Smart Power Consumer software and hardware components can be manufactured to be integrated into an operating system and power supply adapter of a computer, tablet, or generic electrical device, as shown in FIG. 5.

3a. The Smart Power Consumer can be manufactured to only run in automatic mode, as described above in the section: DETAILED DESCRIPTION OF THE INVENTION.

3b. The Smart Power Consumer can be manufactured to only run in manual mode, as described above in the section: DETAILED DESCRIPTION OF THE INVENTION.

3c. Or the Smart Power Consumer can be manufactured to give the user a choice of running in either manual or automatic mode—by making both of these available. Both operating modes: manual and automatic—are described in the above section: DETAILED DESCRIPTION OF THE INVENTION.

4. The GUI control components of the Smart Power Consumer as shown in FIGS. 1, FIG. 2, and FIG. 3 can be aggregated and/or combined to best suit what the manufacturer would consider to be most appropriate for the customer, depending mostly on the type of run modes are available to the consumer.
